(19) United States
(12) Patent Application Publication
(10) Pub. No.: US 2012/0133863 A1
(43) Pub. Date: May 31, 2012

(54) Reflective Polymer Dispersed Liquid Crystal Display Device

(75) Inventors: Yong-wan Jin, Seoul (KR); Kyu-young Hwang, Ansan-si (KR); Jae-eun Jang, Seoul (KR); Gae-hwang Lee, Hwaseong-si (KR)

(73) Assignee: SAMSUNG ELECTRONICS CO., LTD., Suwon-si (KR)

(21) Appl. No.: 13/169,597

(22) Filed: Jun. 27, 2011

(30) Foreign Application Priority Data
Nov. 25, 2010 (KR) 10-2010-0118106

(51) Int. Cl. G02F 1/1334

(52) U.S. Cl. 349/86

(57) ABSTRACT

A reflective polymer dispersed liquid crystal (PDLC) display device includes a PDLC layer between first and second electrodes, the PDLC layer including polymers, liquid crystals, and dichroic dyes having negative dichroism.

### CROSS-REFERENCE TO RELATED APPLICATIONS

This application claims the benefit of Korean Patent Application No. 10-2010-0118106, filed on Nov. 25, 2010, in the Korean Intellectual Property Office, the entire contents of which are incorporated herein by reference.

### BACKGROUND

1. Field

Example embodiments relate to reflective display devices, and more particularly, to reflective polymer dispersed liquid crystal (PDLC) display devices.

2. Description of the Related Art

Polymers and liquid crystals are uniformly distributed in polymer dispersed liquid crystals (PDLCs). When an electric field is applied to PDLCs, optical refractive indices of polymers and liquid crystals are changed. Accordingly, PDLCs may scatter or transmit light by adjusting a refractive index difference between liquid crystals and polymers due to an electric field, and thus may be applied to a reflective display device for displaying information or an image by using an external light source. If dichroic dyes are mixed with PDLCs, a display device having a higher contrast may be achieved.

### SUMMARY

Example embodiments provide reflective polymer dispersed liquid crystal (PDLC) display devices. Additional aspects will be set forth in part in the description which follows and, in part, will be apparent from the description, or may be learned by practice of example embodiments.

According to example embodiments, a PDLC display device may include a plurality of pixel units, and each of the plurality of pixel units includes first and second substrates spaced apart from each other, a plurality of first and second electrodes on the first and second substrates, respectively, and a PDLC layer between the plurality of first and second electrodes, the PDLC layer including polymers, liquid crystals, and dichroic dyes having negative dichroism.

First and second voltages may be applied to the plurality of pixel units, the first voltage being less than the second voltage. The dichroic dyes may be arranged in a direction perpendicular to the first and second substrates to transmit light when the first voltage is applied to the plurality of pixel units. The dichroic dyes may also be arranged randomly to absorb light when the second voltage is applied to the plurality of pixel units.

Each of the plurality of pixel units may further include a mirror reflective plate on the first substrate. The mirror reflective plate may be composed of at least one of a metal thin film, a dielectric thin film, and a mixture thin film of a metal and a dielectric.

The plurality of first electrodes may be formed to correspond to the plurality of pixel units, and the plurality of second electrodes may be integrally formed to constitute a common electrode. The plurality of first and second electrodes may be formed in a stripe shape to intersect each other.

Each of the plurality of pixel units may further include a color filter on one of the first and second substrates, the color filter including color filter layers having a plurality of colors, and a mirror reflective plate on the first substrate.

The color filter layers may be at least one of red, green, and blue color filter layers, and cyan, magenta, and yellow color filter layers. The plurality of first electrodes may be formed to correspond to the pixel units, and the plurality of second electrodes may be integrally formed to constitute a common electrode. The plurality of first and second electrodes may be formed in a stripe shape to intersect each other.

Each of the plurality of pixel units may further include a color reflective plate on the first substrate, the color reflective plate including reflective plates having a plurality of colors. The color reflective plate may include at least two dielectric thin films that are alternately stacked. The color reflective plate may reflect light of different colors according to a thickness of each of the at least two dielectric thin films. The color reflective plate may further include a mirror reflective film under the dielectric thin films.

The plurality of first electrodes may be formed to correspond to the pixel units, and the plurality of second electrodes may be integrally formed to constitute a common electrode. The plurality of first and second electrodes may be formed in a stripe shape to intersect each other.

### BRIEF DESCRIPTION OF THE DRAWINGS

These and/or other aspects will become apparent and more readily appreciated from the following description of example embodiments, taken in conjunction with the accompanying drawings of which:

FIGS. 1 and 2 are cross-sectional views illustrating a reflective polymer dispersed liquid crystal (PDLC) display device according to example embodiments;

FIG. 3 is a graph illustrating a relationship between a light transmittance and a voltage applied to dichroic dyes having negative dichroism;

FIGS. 4 and 5 are cross-sectional views illustrating a reflective PDLC display device according to example embodiments; and

FIGS. 6 and 7 are cross-sectional views illustrating a reflective PDLC display device according to example embodiments.

### DETAILED DESCRIPTION

Example embodiments will now be described more fully with reference to the accompanying drawings, in which example embodiments are shown. In the drawings, like reference numerals denote like elements, and the thicknesses of elements may be exaggerated for clarity.

Although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” if used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined

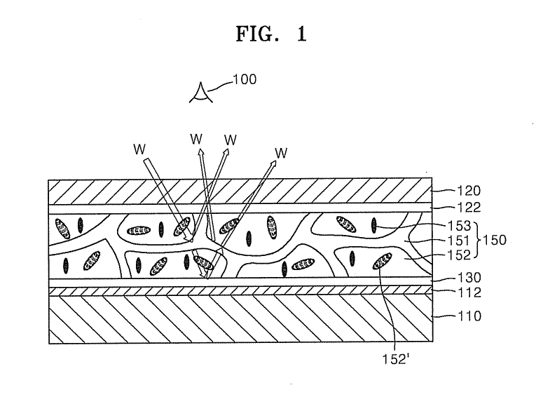

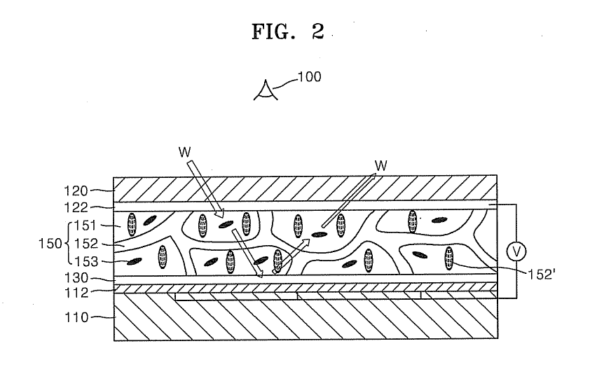

FIGS. 1 and 2 are cross-sectional views illustrating a reflective polymer dispersed liquid crystal (PDLC) display device according to example embodiments. In detail, FIG. 1 is a cross-sectional view illustrating a state where no voltage is applied to a PDLC layer 150. FIG. 2 is a cross-sectional view illustrating a state where a voltage V is applied to the PDLC layer 150.

The reflective PDLC display device of FIGS. 1 and 2 includes a plurality of pixel units. Only one pixel unit of the plurality of pixel units is illustrated in FIGS. 1 and 2 for convenience, and the same goes in the following drawings. Referring to FIGS. 1 and 2, the reflective PDLC display device includes first and second substrates 110 and 120 spaced apart from each other, a plurality of first and second electrodes 112 and 122 that are respectively formed on the first and second substrates 110 and 120, the PDLC layer 150 disposed between the first electrodes 112 and the second electrodes 122, and a mirror reflective plate 130 on the first substrate 110.

The first substrate 110, which is a lower substrate, and the second substrate 120, which is an upper substrate, may be transparent substrates. The first and second substrates 110 and 120 may be formed of, for example, glass or plastic. However, example embodiments are not limited thereto, and the first and second substrates 110 and 120 may be formed of any of various materials. The plurality of first electrodes 112 may be formed on a top surface of the first substrate 110, and the plurality of second electrodes 122 may be formed on a bottom surface of the second substrate 120. Each of the first and second electrodes 112 and 122 may be formed of a transparent conductive material, e.g., indium tin oxide (ITO).

If the reflective PDLC display device of FIGS. 1 and 2 is an active matrix (AM) display device, the first electrodes 112 may be formed in shapes corresponding to the pixel units, and the second electrodes 122 may be integrally formed to constitute a common electrode. A thin film transistor (TFT) for switching a voltage applied to each of the pixel units may be connected to each of the first electrodes 112. If the reflective PDLC display device of FIGS. 1 and 2 is a passive matrix (PM) display device, the first electrodes 112 may be formed in stripe shapes and arranged parallel to one another, and the second electrodes 122 may be formed in stripe shapes and arranged parallel to one another to intersect the first electrodes 112.

The PDLC layer 150 may be formed between the first electrodes 112 and the second electrodes 122. Polymers 151, liquid crystals 152, and dichroic dyes 153 may be dispersed in the PDLC layer 150. The polymers 151 may have a network structure in the PDLC layer 150, and the liquid crystals 152 and the dichroic dyes 153 having optical dichroism may be uniformly dispersed in between the polymers 151.

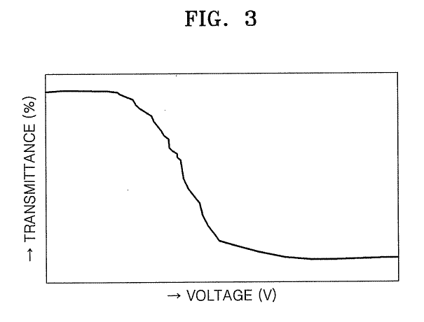

In FIGS. 1 and 2, the dichroic dyes 153 have negative dichroism. At a voltage less than a predetermined or given voltage, for example, when no voltage is applied, the dichroic dyes 153 having negative dichroism may be arranged in a direction perpendicular to the first and second substrates 110 and 120 to transmit light, and at a voltage higher than the predetermined or given voltage, the dichroic dyes 153 having negative dichroism may be arranged randomly to absorb light. FIG. 3 is a graph illustrating a relationship between a light transmittance and a voltage applied to the dichroic dyes 153 having negative dichroism. Referring to FIG. 3, the dichroic dyes 153 have a high light transmittance at a voltage less than a predetermined or given voltage, and have a low light transmittance at a voltage higher than the predetermined or given voltage. Dichroic dyes having positive dichroism absorb light at a voltage less than a predetermined or given voltage and transmit light at a voltage higher than the predetermined or given voltage.

The mirror reflective plate 130 may be disposed on top surfaces of the first electrodes 112. The mirror reflective plate 130 may be for providing mirror reflection and may be formed of a metal thin film, e.g., aluminum (Al) or chromium (Cr). However, example embodiments are not limited thereto, and the mirror reflective plate 130 may be formed of a dielectric thin film or a mixture thin film of a metal and a dielectric. While the mirror reflective plate 130 is disposed on the top surfaces of the first electrodes 112 in FIGS. 1 and 2, example embodiments are not limited thereto and the mirror reflective plate 130 may be disposed on a bottom surface of the first substrate 110 or bottom surfaces of the first electrodes 112.

A process of driving the reflective PDLC display device of FIGS. 1 and 2 will now be explained. Referring to FIG. 1, when no voltage is applied between the first electrodes 112 and the second electrodes 122 of the pixel units, liquid crystal molecules 152′ are arranged randomly in the PDLC layer 150. In a state where the liquid crystal molecules 152′ are arranged randomly, white light W incident from an external light source (e.g., the sun) is scattered due to a refractive index difference between the polymers 151 and the liquid crystals 152. Due to having negative dichroism, the dichroic dyes 153 are arranged in a direction perpendicular to the first and second substrates 110 and 120 to transmit light. Accordingly, the white light W incident into the PDLC layer 150 passes through the dichroic dyes 153 arranged in a direction perpendicular to the first and second substrates 110 and 120.

As such, when no voltage is applied between the first electrodes 112 and the second electrodes 122, the white light W incident from the external light source is scattered in various directions between the polymers 151 and the liquid crystals 152 while passing through the dichroic dyes 153. Part of the scattered light passes through the second substrate 120 (without being reflected by the mirror reflective plate 130), and another part of the scattered light is reflected by the mirror reflective plate 130, is scattered again, and passes through the second substrate 120. Accordingly, an observer 100 located over the second substrate 120 perceives the pixel units as being white.

Referring to FIG. 2, when a voltage V higher than a predetermined or given voltage is applied between the first electrodes 112 and the second electrodes 122 of the pixel units, the liquid crystal molecules 152′ may be arranged in a direction parallel to an electric field, that is, in a direction perpendicular to the first and second substrates 110 and 120, in the PDLC layer 150. In a state where the liquid crystal molecules 152′ are arranged in a direction perpendicular to the first and second substrates 110 and 120, white light W incident from an external light source passes through the polymers 151 and the liquid crystals 152 as a refractive index of the polymers 151 and a refractive index of the liquid crystals 152 become similar to each other. Due to having negative dichroism, the dichroic dyes 153 may be arranged randomly to transmit light.

Accordingly, the white light W incident into the PDLC layer 150 and traveling toward the dichroic dyes 153 may be absorbed by the dichroic dyes 153. As such, when a voltage V is applied between the first electrodes 112 and the second electrodes 122, the white light W incident from the external light source passes through the polymers 151 and the liquid crystals 152, and part of the white light W may be absorbed by the dichroic dyes 153. Part of the white light W not absorbed by the dichroic dyes 153 may be reflected by the mirror reflective plate 130 and may pass through the second substrate 120. During this procedure, part of the white light W reflected by the mirror reflective plate 130 may be absorbed again by the dichroic dyes 153.

Because the mirror reflective plate 130 reflects external incident light at an angle exceeding a specific angle, that is, a viewing angle of the observer 100, the observer 100 perceives the pixel units as being black. Because the dichroic dyes 153 having negative dichroism absorb part of external incident light or light reflected at an angle exceeding a viewing angle of the observer 100 when a voltage V is applied between the first electrodes 112 and the second electrodes 122, a contrast and a reflectance of the reflective PDLC display device may be improved.

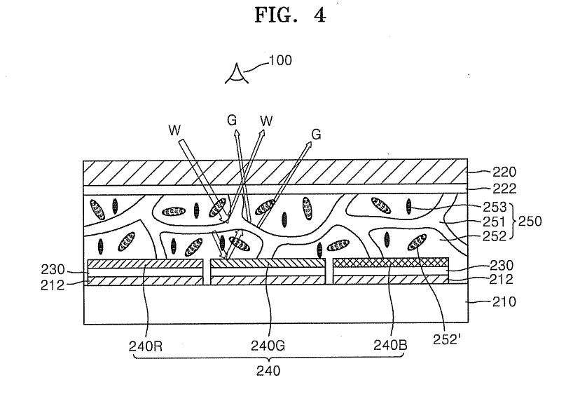

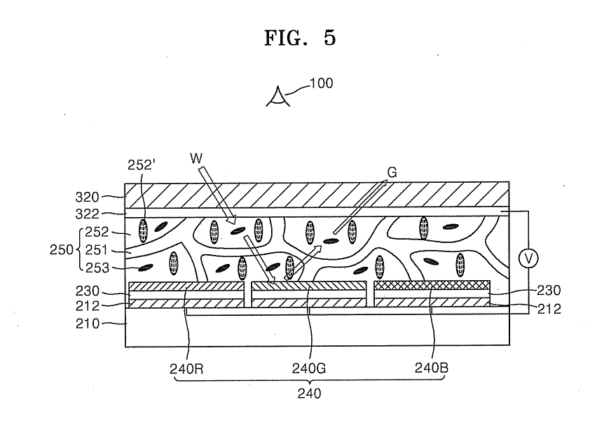

FIGS. 4 and 5 are cross-sectional views illustrating a reflective PDLC display device according to example embodiments. In detail, FIG. 4 is a cross-sectional view illustrating a state where no voltage is applied to a PDLC layer 250. FIG. 5 is a cross-sectional view illustrating a case where a voltage V is applied to the PDLC layer 250. The following explanation will be focused on a difference between the reflective PDLC display device of FIGS. 4 and 5 and the reflective PDLC display device of FIGS. 1 and 2.

The reflective PDLC display device of FIGS. 4 and 5 includes a plurality of pixel units, and each of the pixel units includes sub-pixels of a plurality of colors. The following explanation will be made on the assumption that each of the pixel units includes red, green, and blue sub-pixels. However, example embodiments are not limited thereto, and each of the pixel units may include cyan, magenta, and yellow sub-pixels, or sub-pixels of various other colors.

Referring to FIGS. 4 and 5, a first substrate 210 and a second substrate 220 may be spaced apart from each other. A plurality of first electrodes 212 may be disposed on a top surface of the first substrate 210, and a plurality of second electrodes 222 may be disposed on a bottom surface of the second substrate 220. A mirror reflective plate 230 may be disposed on top surfaces of the first electrodes 212, and a color filter 240 may be disposed on a top surface of the mirror reflective plate 230. The PDLC layer 250 may be disposed between the first electrodes 212 and the second electrodes 222.

The first substrate 210 and the second substrate 220 may be transparent substrates, and each of the first and second electrodes 212 and 222 may be formed of a transparent conductive material. If the reflective PDLC display device of FIGS. 4 and 5 is an AM display device, the first electrodes 212 may be formed in shapes corresponding to the pixel units, and the second electrodes 222 may be integrally formed to constitute a common electrode. If the reflective PDLC display device of FIGS. 4 and 5 is a PM display device, the first and second electrodes 212 and 222 may be formed in stripe shapes to intersect each other.

The mirror reflective plate 230 may be disposed on the top surfaces of the first electrodes 212. The mirror reflective plate 230 may be formed of, for example, a metal thin film, a dielectric thin film, or a mixture thin film of a metal and a dielectric. Although the mirror reflective plate 230 is disposed on the top surfaces of the first electrodes 212 in FIGS. 4 and 5, example embodiments are not limited thereto and the mirror reflective plate 230 may be disposed on a bottom surface of the first substrate 210 or bottom surfaces of the first electrodes 212.

The color filter 240 may be disposed on the top surface of the mirror reflective plate 230. The color filter 240 may include red, green, and blue color filter layers 240R, 240G, and 240B corresponding to the sub-pixels. However, example embodiments are not limited thereto, and the color filter 240 may include cyan, magenta, and yellow color filter layers, or color filter layers of various other colors. Although the color filter 240 is disposed on a side of the first substrate 210 in FIGS. 4 and 5, the color filter 240 may be disposed on a side of the second substrate 220.

The PDLC layer 250 may be formed between the first electrodes 212 and the second electrodes 222. Polymers 251, liquid crystals 252, and dichroic dyes 253 may be dispersed in the PDLC layer 250. The polymers 251 may have a network structure in the PDLC layer 250, and the liquid crystals 252 and the dichroic dyes 253 having negative dichroism may be uniformly dispersed in between the polymers 251. At a voltage less than a predetermined or given voltage, for example, when no voltage is applied, the dichroic dyes 253 having negative dichroism may be arranged in a direction perpendicular to the first and second substrates 210 and 220 to transmit light, and at a voltage higher than the predetermined or given voltage, the dichroic dyes 253 having negative dichroism may be arranged randomly to absorb light, as described above.

A process of driving the reflective PDLC display device of FIGS. 4 and 5 will now be explained. Referring to FIG. 4, when no voltage is applied between the first electrodes 212 and the second electrodes 222 of the pixel units, liquid crystal molecules 252′ may be arranged randomly in the PDLC layer 250. In a state where the liquid crystal molecules 252′ are arranged randomly, white light W incident from an external light source may be scattered due to a refractive index difference between the polymers 251 and the liquid crystals 252. Due to having negative dichroism, the dichroic dyes 253 may be arranged in a direction perpendicular to the first and second substrates 210 and 220 to transmit light.

Accordingly, the white light W incident into the PDLC layer 250 may pass through the dichroic dyes 253 arranged in a direction perpendicular to the first and second substrates 210 and 220. As such, when no voltage is applied between the first electrodes 212 and the second electrodes 222, the white light W incident from the external light source may be scattered in various directions while passing through the dichroic dyes 253.

Part of the scattered light passes through the second substrate 220 (without being reflected by the mirror reflective plate 230), and another part of the scattered light passes through, for example, the green color filter layer 240G, is reflected by the mirror reflective plate 230, is scattered again, and passes through the second substrate 220. Accordingly, green light G may be emitted from the second substrate 220, and thus the observer 100 perceives the pixel units as being green.

Referring to FIG. 5, when a voltage V higher than a predetermined or given voltage is applied between the first electrodes 212 and the second electrodes 222 of the pixel units, the liquid crystal molecules 252′ may be arranged in a direction parallel to an electric field, that is, a direction perpendicular to the first and second substrates 210 and 220, in the PDLC layer 250. In a state where the liquid crystal molecules 252′ are arranged in a direction perpendicular to the first and second substrates 210 and 220, white light W incident from an external light source may pass through the polymers 251 and the liquid crystals 252 as a refractive index of the polymers 251 and a refractive index of the liquid crystals 252 become similar to each other.

Due to having negative dichroism, the dichroic dyes 253 may be arranged randomly to absorb light. Accordingly, the white light W incident into the PDLC layer 250 and traveling toward the dichroic dyes 253 may be absorbed by the dichroic dyes 253. As such, when a voltage V is applied between the first electrodes 212 and the second electrodes 222, the white light W incident from the external light source may pass through the polymers 251 and the liquid crystals 252, and part of the white light W may be absorbed by the dichroic dyes 253.

Part of the white light W not absorbed by the dichroic dyes 253 may pass through, for example, the green color filter layer 240G, be reflected by the mirror reflective plate 230, and pass through the second substrate 220. Part of the green light G reflected by the mirror reflective plate 230 may be absorbed by the dichroic dyes 253. Because the mirror reflective plate 230 reflects external incident light at an angle exceeding a specific angle, that is, a viewing angle of the observer 100, the observer 100 perceives the pixel units as being black. Because the dichroic dyes 253 having negative dichroism absorb part of external incident light or light reflected at an angle exceeding a viewing angle of the observer 100 when a voltage V is applied between the first electrodes 212 and the second electrodes 222 in FIGS. 4 and 5, a contrast and a reflectance of the reflective PDLC display device may be improved.

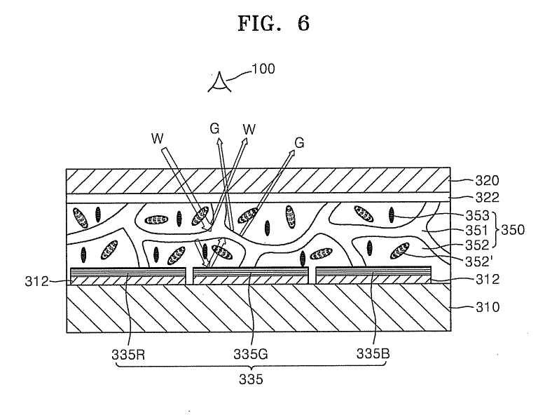

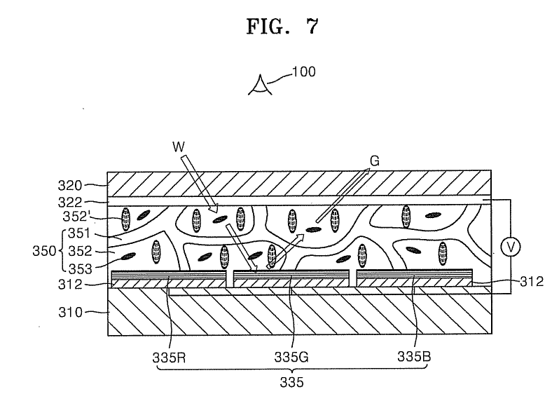

FIGS. 6 and 7 are cross-sectional views illustrating a reflective PDLC display device according to example embodiments. In detail, FIG. 6 is a cross-sectional view illustrating a state where no voltage is applied to a PDLC layer 350. FIG. 7 is a cross-sectional view illustrating a case where a voltage V is applied to the PDLC layer 350. The following explanation will be focused on a difference between the reflective PDLC display device of FIGS. 6 and 7 and the reflective PDLC display devices of FIGS. 1 and 2 and FIGS. 4 and 5. The reflective PDLC display device of FIGS. 6 and 7 includes a plurality of pixel units, and each of the pixel units includes sub-pixels of a plurality of colors. Although the following explanation will be made on the assumption that each of the pixel units includes red, green, and blue sub-pixels, each of pixel units may include cyan, magenta, and yellow sub-pixels, or sub-pixels of various other colors.

Referring to FIGS. 6 and 7, a first substrate 310 and a second substrate 320 may be spaced apart from each other, a plurality of first electrodes 312 may be disposed on a top surface of the first substrate 310, and a plurality of second electrodes 322 may bee disposed on a bottom surface of the second substrate 320. The first substrate 310 and the second substrate 320 may be transparent substrates, and each of the first and second electrodes 312 and 322 may be formed of a transparent conductive material.

A color reflective plate 335 may be disposed on top surfaces of the first electrodes 312. The color reflective plate 335 may be for reflecting only light of predetermined or given colors from among incident light and may include, for example, red, green, and blue reflective plates 335R, 335G, and 335B. However, example embodiments are not limited thereto, and the color reflective plate 335 may include cyan, magenta, and yellow reflective plates, or reflective plates of various other colors. In FIGS. 6 and 7, the color reflective plate 335 may act as the color filter 240 and the mirror reflective plate 230 in FIGS. 4 and 5. The color reflective plate 335 may be formed by alternately stacking at least two dielectric thin films. Light of a desired color may be reflected by adjusting thicknesses of the stacked dielectric thin films.

Although the color reflective plate 335 is disposed on the top surfaces of the first electrodes 312 in FIGS. 6 and 7, the color reflective plate 335 may be disposed on a bottom surface of the first substrate 310 or bottom surfaces of the first electrodes 312. Although not shown, a mirror reflective film may be further disposed on a bottom surface of the color reflective plate 335. The mirror reflective film (not shown) is for reflecting light transmitting through the color reflective plate 335 and may be formed of a metal thin film, a dielectric thin film, or a mixture thin film of a metal and a dielectric.

The PDLC layer 350 may be formed between the first electrodes 312 and the second electrodes 332. Polymers 351, liquid crystals 352, and dichroic dyes 353 may be dispersed in the PDLC layer 350. The polymers 351 have a network structure in the PDLC layer 350, and the liquid crystals 352 and the dichroic dyes 353 having negative dichroism may be uniformly dispersed in between the polymers 351. At a voltage less than a predetermined or given voltage, for example, when no voltage is applied, the dichroic dyes 353 having negative dichroism may be arranged in a direction perpendicular to the first and second substrates 310 and 320 to transmit light, and at a voltage higher than the predetermined or given voltage, the dichroic dyes 353 having negative dichroism may be arranged randomly to absorb light, as described above.

A process of driving the reflective PDLC display device of FIGS. 6 and 7 will now be explained. Referring to FIG. 6, when no voltage is applied between the first electrodes 312 and the second electrodes 322 of the pixel units, liquid crystal molecules 352′ may be arranged randomly in the PDLC layer 350. In a state where the liquid crystal molecules 352′ are arranged randomly, white light W incident from an external light source may be scattered due to a refractive index difference between the polymers 351 and the liquid crystals 352. Due to having negative dichroism, the dichroic dyes 353 may be arranged in a direction perpendicular to the first and second substrates 310 and 320 to transmit light. Accordingly, the white light W incident into the PDLC layer 350 passes through the dichroic dyes 353 arranged in a direction perpendicular to the first and second substrates 310 and 320.

As such, when no voltage is applied between the first electrodes 312 and the second electrodes 322, the white light W incident from the external light source may be scattered in various directions while passing through the dichroic dyes 353. Part of the scattered light passes through the second substrate 320 (without being reflected by the color reflective plate 335), and another part of the scattered light may be reflected by, for example, the green reflective plate 335G, scattered again, and pass through the second substrate 320. Accordingly, green light G may be emitted from the second substrate 320, and thus, the observer 100 perceives the pixel units as being green.

Referring to FIG. 7, when a voltage V higher than a predetermined or given voltage is applied between the first electrodes 312 and the second electrodes 322 of the pixel units, the liquid crystal molecules 352′ may be arranged in a direction parallel to an electric field, that is, a direction perpendicular to the first and second substrates 310 and 320, in the PDLC layer 350. In a state where the liquid crystal molecules 352′ are arranged in a direction perpendicular to the first and second substrates 310 and 320, white light W incident from an external light source passes through the polymers 361 and the liquid crystals 352 as a refractive index of the polymers 351 and a refractive index of the liquid crystals 352 become similar to each other. Due to having negative dichroism, the dichroic dyes 353 may be arranged randomly to absorb light. Accordingly, the white light W incident into the PDLC layer 350 and traveling toward the dichroic dyes 353 may be absorbed by the dichroic dyes 353. As such, when a voltage V is applied between the first electrodes 312 and the second electrodes 322, the white light W incident from the external light source passes through the polymers 351 and the liquid crystals 352, and part of the white light W may be absorbed by the dichroic dyes 353.

Part of the white light W not absorbed by the dichroic dyes 353 is reflected by, for example, the green reflective plate 335G, and passes through the second substrate 320. Part of the green light G reflected by the green reflective plate 335G may be absorbed by the dichroic dyes 353. Because the color reflective plate 335 reflects external incident light at an angle exceeding a specific angle, that is, a viewing angle of the observer 100, the observer 100 perceives the pixel units as being black. Because the dichroic dyes 353 having negative dichroism absorb part of external incident light or light reflected at an angle exceeding a viewing angle of the observer 100 when a voltage V is applied between the first electrodes 312 and the second electrodes 322 in FIGS. 6 and 7, a contrast and a reflectance of the reflective PDLC display device may be improved.

### Experimental Example 1

An aluminum reflective film is deposited to a thickness of 2000 Å on an ITO electrode of a lower substrate, and a color filter is coated to a thickness of 1 μm on the aluminum reflective film. An upper substrate coated with an ITO electrode is spaced apart from the lower substrate by an interval of about 10 μm, and a solution obtained by mixing 19.7% by weight of PN393 (photocurable monomers provided by Merk), 80% by weight of TL203 (liquid crystals provided by Merk), and 0.3% by weight of dichroic dyes having negative dichroism is injected between the upper substrate and the lower substrate. A PDLC layer may be formed between the upper substrate and the lower substrate by using ultraviolet (UV) curing. A reflectance and a contrast of a reflective PDLC display device prepared by the aforementioned method were 35% and 100:1, respectively.

### Experimental Example 2

A chrome reflective film is deposited to a thickness of 2000 Å on an ITO electrode of a lower substrate, and a color filter is coated on the chrome reflective film. The color reflective plate may be formed by alternately depositing an Si₃N₄ layer and an SiO₂ layer to thicknesses of 15 nm and 10 nm, respectively, on the chrome reflective film, and repeating the alternating deposition 10 times. An upper substrate coated with an ITO electrode is spaced apart from the lower substrate by an interval of about 10 μm, and a solution obtained by mixing 19.7% by weight of PN393 (photocurable monomers provided by Merk), 80% by weight of TL203 (liquid crystals provided by Merk), and 0.3% by weight of dichroic dyes having negative dichroism is injected between the upper substrate and the lower substrate. A PDLC layer may be formed between the upper substrate and the lower substrate by using UV curing. A reflectance and a contrast of a reflective PDLC display device prepared by the aforementioned method were 25% and 100:1, respectively.

### Experimental Example 3

An aluminum reflective film is deposited to a thickness of 2000 Å on an ITO electrode of a lower substrate, and a color filter is coated to a thickness of 1 μm on the aluminum reflective film. An upper substrate coated with an ITO electrode is spaced apart from the lower substrate by an interval of about 10 μm, and a solution obtained by mixing 19.7% by weight of PN393 (photocurable monomers provided by Merk), 80% by weight of TL203 (liquid crystals provided by Merk), and 0.3% by weight of dichroic dyes having positive dichroism is injected between the upper substrate and the lower substrate. A PDLC layer may be formed between the upper substrate and the lower substrate by using UV curing. A reflectance and a contrast of a reflective PDLC display device prepared by the aforementioned method were 15% and 100:1, respectively.

As shown in Experimental Examples 1 through 3, the reflective PDLC display device using the dichroic dyes having negative dichroism according to Experimental Examples 1 and 2 have a higher reflectance and a higher contrast than the reflective PDLC display device according to Experimental Example 3 using the dichroic dyes having positive dichroism.

According to example embodiments, because a PDLC layer includes dichroic dyes having negative dichroism, a reflective PDLC display device having a higher contrast and a higher reflectance may be achieved. While the inventive concepts have been particularly shown and described with reference to example embodiments thereof, the embodiments and terms have been used to explain the inventive concepts and should not be construed as limiting the scope of the claims. Accordingly, it will be understood by those of ordinary skill in the art that various changes in form and details may be made therein without departing from the spirit and scope of the following claims.

What is claimed is:

1. A reflective polymer dispersed liquid crystal (PDLC) display device comprising a plurality of pixel units, each of the plurality of pixel units including,
first and second substrates spaced apart from each other;
a plurality of first and second electrodes on the first and second substrates, respectively; and
a PDLC layer between the plurality of first and second electrodes, the PDLC layer including polymers, liquid crystals, and dichroic dyes having negative dichroism.

2. The reflective PDLC display device of claim 1, wherein first and second voltages are applied to the plurality of pixel units, the first voltage being less than the second voltage.

3. The reflective PDLC display device of claim 2, wherein the dichroic dyes are arranged in a direction perpendicular to the first and second substrates to transmit light when the first voltage is applied to the plurality of pixel units.

4. The reflective PDLC display device of claim 2, wherein the dichroic dyes are arranged randomly to absorb light when the second voltage is applied to the plurality of pixel units.

5. The reflective PDLC display device of claim 1, wherein each of the plurality of pixel units further comprises a mirror reflective plate on the first substrate.

6. The reflective PDLC display device of claim 5, wherein the mirror reflective plate is composed of at least one of a metal thin film, a dielectric thin film, and a mixture thin film of a metal and a dielectric.

7. The reflective PDLC display device of claim 1, wherein the plurality of first electrodes are formed to correspond to the plurality of pixel units, and the plurality of second electrodes are integrally formed to constitute a common electrode.

8. The reflective PDLC display device of claim 1, wherein the plurality of first and second electrodes are formed in a stripe shape to intersect each other.

9. The reflective PDLC display device of claim 1, wherein each of the plurality of pixel units further comprises:
a color filter on one of the first and second substrates, the color filter including color filter layers having a plurality of colors; and
a mirror reflective plate on the first substrate.

10. The reflective PDLC display device of claim 9, wherein the mirror reflective plate is composed of at least one of a metal thin film, a dielectric thin film, and a mixture thin film of a metal and a dielectric.

11. The reflective PDLC display device of claim 9, wherein the color filter layers are at least one of red, green, and blue color filter layers, and cyan, magenta, and yellow color filter layers.

12. The reflective PDLC display device of claim 9, wherein the plurality of first electrodes are formed to correspond to the pixel units, and the plurality of second electrodes are integrally formed to constitute a common electrode.

13. The reflective PDLC display device of claim 9, wherein the plurality of first and second electrodes are formed in a stripe shape to intersect each other.

14. The reflective PDLC display device of claim 1, wherein each of the plurality of pixel units further comprises:
a color reflective plate on the first substrate, the color reflective plate including reflective plates having a plurality of colors.

15. The reflective PDLC display device of claim 14, wherein the color reflective plate comprises at least two dielectric thin films that are alternately stacked.

16. The reflective PDLC display device of claim 15, wherein the color reflective plate reflects light of different colors according to a thickness of each of the at least two dielectric thin films.

17. The reflective PDLC display device of claim 15, wherein the color reflective plate further comprises a mirror reflective film under the dielectric thin films.

18. The reflective PDLC display device of claim 14, wherein the plurality of first electrodes are formed to correspond to the pixel units, and the plurality of second electrodes are integrally formed to constitute a common electrode.

19. The reflective PDLC display device of claim 14, wherein the plurality of first and second electrodes are formed in a stripe shape to intersect each other.
